(19) United States
(12) Patent Application Publication
(10) Pub. No.: US 2024/0037639 A1
(43) Pub. Date: Feb. 1, 2024

(54) VIRTUAL REALITY SHOPPING SYSTEM

(71) Applicant: TA'NESHA RATLIFF, Marietta, GA (US)

(72) Inventor: TA'NESHA RATLIFF, Marietta, GA (US)

(21) Appl. No.: 17/873,221

(22) Filed: Jul. 26, 2022

(51) Int. Cl. G06Q 30/06; G06F 3/01; G06F 3/16; G06Q 50/30; G06Q 50/10; G06F 1/16

(52) U.S. Cl. CPC G06Q 30/0643; G06F 3/014; G06F 3/013; G06F 3/167; G06F 3/017; G06Q 50/30; G06Q 50/10; G06F 1/163

(57) ABSTRACT

The virtual reality shopping system is a virtual reality system. The virtual reality shopping system is adapted for use with a client. The virtual reality shopping system provides a virtual environment that emulates the physical process of procuring one or more services. The virtual reality shopping system is a virtual shopping center. The virtual reality shopping system comprises a directory structure, an environment generation structure, and a plurality of avatars. The directory structure presents a virtual “storefront” that is presented to the client by vendors that are willing to enter into a contractual arrangement with the client. The environment generation structure transforms the virtual storefront into a virtual environment for the client. The plurality of avatars are virtual representations for the client and a virtual individual who represents the virtual storefront within the generated virtual environment.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of graphical representation of items or shoppers. (G06Q30/0643)

### SUMMARY OF INVENTION

The virtual reality shopping system is a virtual reality system. The virtual reality shopping system is adapted for use with a client. The virtual reality shopping system provides a virtual environment that emulates the physical process of procuring one or more services. The virtual reality shopping system is a virtual shopping center. The virtual reality shopping system comprises a directory structure, an environment generation structure, and a plurality of avatars. The directory structure presents a virtual “storefront” that is presented to the client by vendors that are willing to enter into a contractual arrangement with the client. The environment generation structure transforms the virtual storefront into a virtual environment for the client. The plurality of avatars are virtual representations for the client and a virtual individual who represents the virtual storefront within the generated virtual environment.

These together with additional objects, features and advantages of the virtual reality shopping system will be readily apparent to those of ordinary skill in the art upon reading the following detailed description of the presently preferred, but nonetheless illustrative, embodiments when taken in conjunction with the accompanying drawings.

In this respect, before explaining the current embodiments of the virtual reality shopping system in detail, it is to be understood that the virtual reality shopping system is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the virtual reality shopping system.

It is therefore important that the claims be regarded as including such equivalent construction insofar as they do not depart from the spirit and scope of the virtual reality shopping system. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a detail view of an embodiment of the disclosure.

FIG. 2 is a detail view of an embodiment of the disclosure.

FIG. 3 is a detail view of an embodiment of the disclosure.

FIG. 4 is an in-use view of an embodiment of the disclosure.

FIG. 5 is an in-use view of an embodiment of the disclosure.

FIG. 6 is a schematic view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

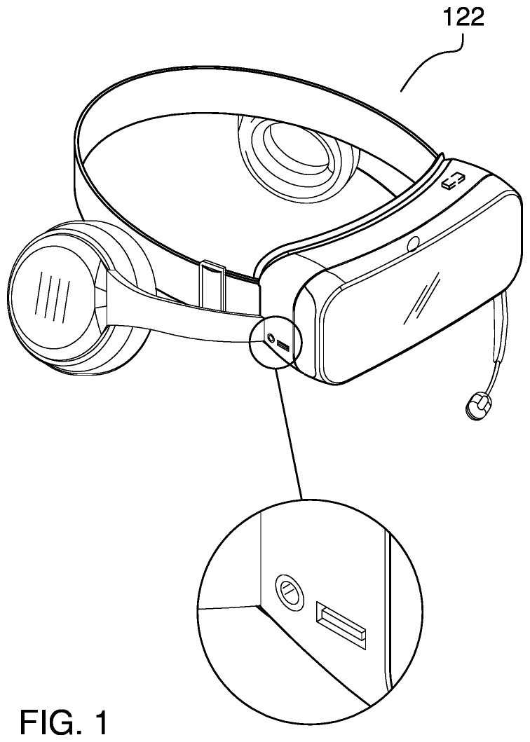

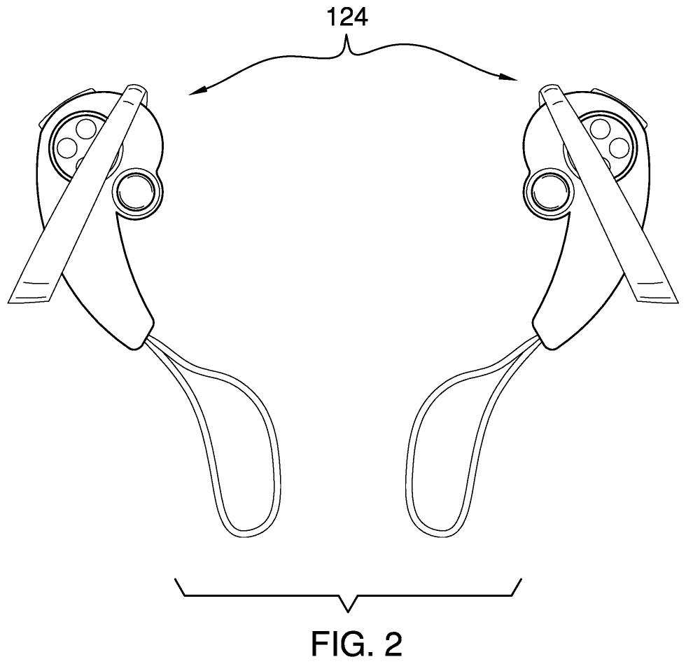

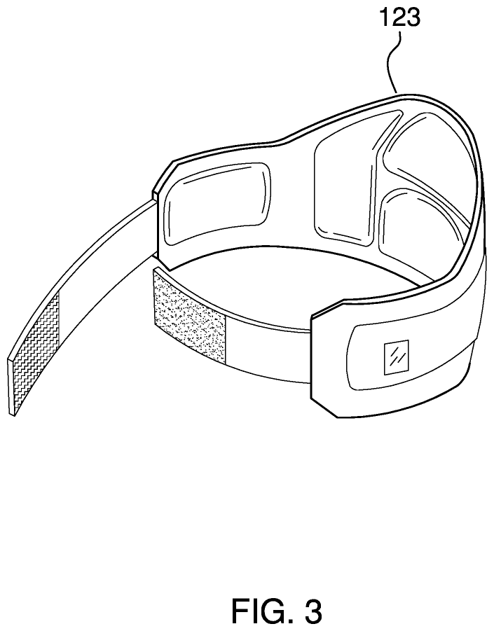

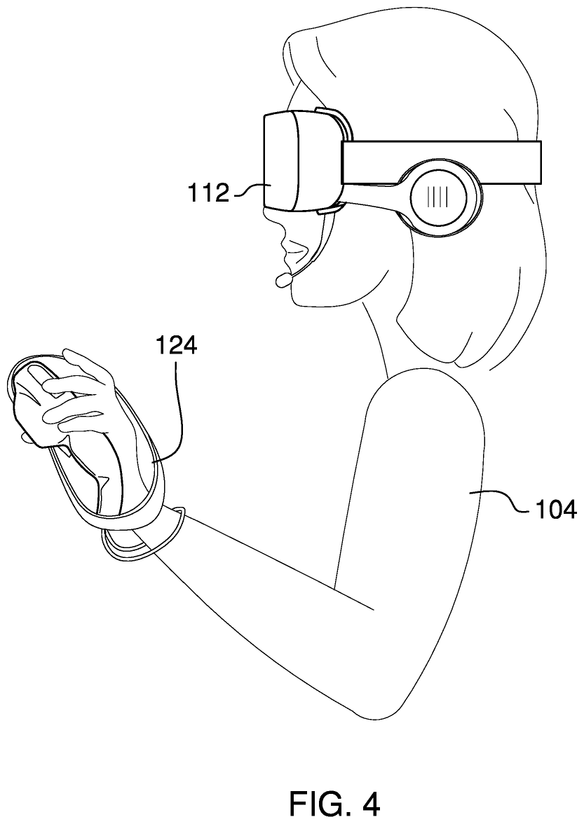

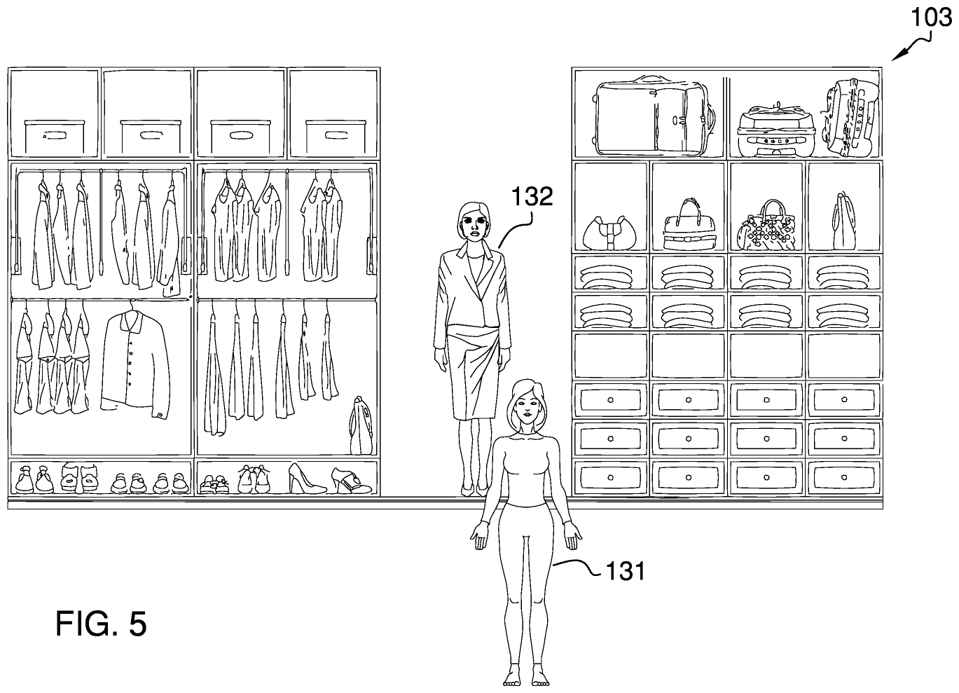

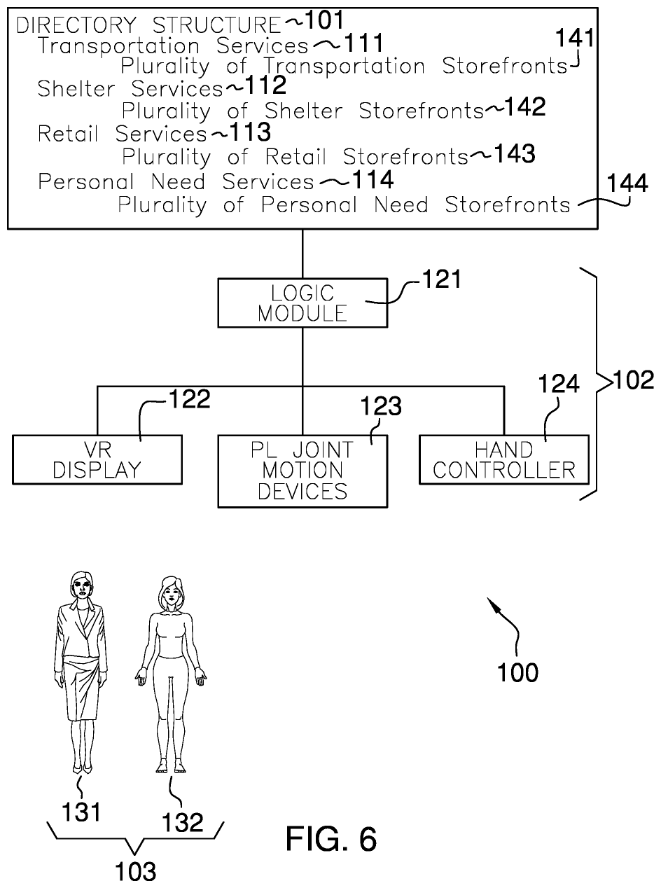

Detailed reference will now be made to one or more potential embodiments of the disclosure, which are illustrated in FIGS. 1 through 6.

The virtual reality shopping system 100 (hereinafter invention) is a virtual reality system. The invention 100 is adapted for use with a client. The invention 100 provides a virtual environment that emulates the physical process of procuring one or more services. The invention 100 is a virtual shopping center. The invention 100 comprises a directory structure 101, an environment generation structure 102, and a plurality of avatars 103. The directory structure 101 presents a virtual “storefront” that is presented to the client by vendors that are willing to enter into a contractual arrangement with the client. The environment generation structure 102 transforms the virtual storefront into a virtual environment for the client. The plurality of avatars 103 are virtual representations for the client and a virtual individual who represents the virtual storefront within the generated virtual environment. The client 104 is defined elsewhere in this disclosure.

The directory structure 101 is a collection of individual virtual storefronts. Each individual virtual storefront selected from the directory structure 101 is a vending organization willing to execute a transaction with the client 104. The selected individual virtual storefront maintains a virtual storefront that the client 104 accesses through the environment generation structure 102. The directory structure 101 comprises transportation services 111, shelter services 112, retail services 113, and personal need services 114.

The transportation services 111 is a subset of individual virtual storefronts selected from the directory structure 101 that are associated with the transportation services 111. The transportation services 111 comprises a plurality of transportation storefronts 141. The individual transportation storefronts 141 contained in the transportation services 111 are focused on the services necessary to transport passengers and cargo. Examples of the individual transportation storefront 141 include, but are not limited to: parcel delivery companies and airlines.

The shelter services 112 is a subset of individual virtual storefronts selected from the directory structure 101 that are associated with the shelter services 112. The shelter services 112 comprises a plurality of shelter storefronts 142. The individual shelter storefronts 142 contained in the shelter services 112 are focused on the services necessary to provide and manage housing for individual clients 104. Examples of the individual shelter storefronts 142 include, but are not limited to: real estate companies, property management companies, and home services companies.

The retail services 113 is a subset of individual virtual storefronts selected from the directory structure 101 that are associated with the retail services 113. The retail services 113 comprises a plurality of retail storefronts 143. The individual retail storefronts 143 contained in the retail services 113 are focused on the sale of domestic articles. Examples of the individual retail storefronts 143 include, but are not limited to: clothing/linen stores, houseware stores, and electronic equipment/office supply retail stores.

The personal need services 114 is a subset of individual virtual storefronts selected from the directory structure 101 that are associated with the personal need services 114. The personal need services 114 comprises a plurality of personal need storefronts 144. The individual personal need storefronts 144 contained in the personal need services 114 are focused on the sale of services. Examples of the individual personal need storefronts 144 include, but are not limited to: home/vehicle repair services, medical/therapeutic services, and food/entertainment services.

The environment generation structure 102 is the structure of the invention 100 that generates the virtual environment the client 104 experiences during the use of the invention 100. The environment generation structure 102 creates a virtual reality structure that interacts with the senses of the client 104.

The environment generation structure 102 presents a first virtual environment that represents a shopping center. The first virtual environment presented by the environment generation structure 102 offers the client 104 access to the individual virtual storefronts that are accessible through the directory structure 101. Upon the selection of an individual virtual storefront by the client 104, the environment generation structure 102 generates a second virtual environment to the client 104 that emulates a shopping experience within the selected individual virtual storefront. The client 104 interacts with the selected individual virtual storefront through the first virtual environment and the second virtual environment to complete a transaction. The environment generation structure 102 directly controls the first virtual environment. The selected individual virtual storefront controls the second virtual environment through the facilities provided by the environment generation structure 102.

The environment generation structure 102 comprises a logic module 121, a virtual reality display device 122, a plurality of joint motion devices 123, and a hand controller 124.

The logic module 121 is a logical device. The logic module 121 forms a communication link with each individual virtual storefront selected from the directory structure 101. The logic module 121 transmits input received from the client 104 to the individual virtual storefront selected from the directory structure 101 by the client 104. The logic module 121 generates the second virtual environment received from the individual virtual storefront for the benefit of the client 104.

The logic module 121 forms a communication link with the client 104. The logic module 121 presents the first virtual environment and the second virtual environment to the client 104. The logic module 121 receives input from the client 104. The logic module 121 uses the input received from the client 104 to adjust the presentation of the first virtual environment to the client. The logic module 121 further uses the input received from the client 104 to adjust the presentation of the second virtual environment to the client. The logic module 121 further uses the input received from the client 104 to facilitate a transaction between the client 104 and the selected individual virtual storefront presenting the second virtual environment.

The virtual reality display device 122 is an interface structure. The virtual reality display device 122 electrically connects to the logic module 121. The logic module 121 controls the operation of the virtual reality display device 122. The virtual reality display device 122 presents to the client 104 the visual stimulation component of the virtual environment being presented to the client 104. The virtual reality display device 122 presents to the client 104 the audible stimulation component of the virtual environment being presented to the client 104.

The virtual reality display device 122 tracks the movement of the eyes of the client 104 and uses the tracked movement to: a) adjust the virtual environment presented to the client 104; and, b) facilitate a transaction between the client 104 and the selected individual virtual storefront. The virtual reality display device 122 tracks the audible sounds made by the client 104 and uses the captured sound to: a) adjust the virtual environment presented to the client 104; and, b) facilitate a transaction between the client 104 and the selected individual virtual storefront. The virtual reality display device 122 further measures the pulse rate, respiration rate, the blood pressure, and the temperature of the client 104. The virtual reality display device 122 provides the pulse rate, respiration rate, the blood pressure, and the temperature of the client 104 to the selected individual virtual storefront interacting with the client 104.

Each joint motion device selected from the plurality of joint motion devices 123 is a sensor. Each joint motion device selected from the plurality of joint motion devices 123 attaches to a joint of the client 104 selected from the group consisting of: a) an elbow of the client 104; b) a wrist of the client 104; c) the knee of the client 104; and d) an ankle of the client 104. Each joint motion device selected from the plurality of joint motion devices 123 forms an electric connection with the logic module 121. The logic module 121 monitors the operation of each joint motion device.

The plurality of joint motion devices 123 are used to capture directional and pointing cues that are generated by the client 104. Each joint motion device selected from the plurality of joint motion devices 123 tracks the motion of its associated joint such that the logic module 121 can use the detected motion to: a) adjust the virtual environment presented to the client 104; and, b) facilitate a transaction between the client 104 and the selected individual virtual storefront.

The hand controller 124 is an interface structure. The hand controller 124 is operated by the client 104. The hand controller 124 allows the client 104 to directly input operating instructions to the logic module 121.

Each avatar selected from the plurality of avatars 103 is an image. The image of each selected avatar presents indicia to the client 104 that stimulates a sentiment that represents the participants of a potential transaction between the client 104 and the selected individual virtual storefront. Each avatar selected from the plurality of avatars 103 is presented in a virtual environment selected from the group consisting of: a) the first virtual environment; b) the second virtual environment; and, c) both the first virtual environment and the second virtual environment. The plurality of avatars 103 comprises a client 104 avatar 131 and a virtual assistant avatar 132.

The client 104 avatar 131 is an avatar selected from the plurality of avatars 103. The client 104 avatar 131 is an image. The client 104 avatar 131 presents indicia that stimulates a sentiment that the client 104 avatar 131 represents the image of the client 104.

The virtual assistant avatar 132 is an avatar selected from the plurality of avatars 103. The virtual assistant avatar 132 is an image. The virtual assistant avatar 132 presents indicia that stimulates a sentiment that the virtual assistant avatar 132 represents the image of the selected individual virtual storefront interacting with the plurality of avatars 103.

The following definitions were used in this disclosure:
Bluetooth™: As used in this disclosure, Bluetooth™ is a standardized communication protocol that is used to wirelessly interconnect electronic devices.
Communication Link: As used in this disclosure, a communication link refers to the structured exchange of data between two objects.
Contract: As used in this disclosure, a contract refers to the legal recognition and documentation of a transaction between two or more parties. The contract is typically a written document and always includes an obligation to take (or not take) an action. The elements of a contract comprise: a) an offer; b) a consideration; c) an acceptance; and, d) a mutual understanding. The offer is a promise from a first party to the contract to take a specifically defined first action (such as perform a service or provide a good). For the purpose of this definition, a promise to take no action is considered a first action. The consideration is a promise from the second party to the first party to take a specifically defined second action that is valued by the first party in compensation for benefiting from the first action. The acceptance refers to an action or process that confirms the contractual obligations between the first party and the second party. The mutual understanding is an understanding between the parties that: a) the first party is obligated to complete the first task and the second party is obligated to complete the second task; with the understanding that, b) if either party cannot perform their specifically defined action the other party is not obligated to complete their specifically defined action.
Database: As used in this disclosure, a database refers to: 1) a set of data that is organized and stored in a manner that allows for the search and retrieval of data from the data set; or, 2) the electronic device that stores and organizes a data set as described in the first definition.
Display: As used in this disclosure, a display is a surface upon which is presented an image, potentially including, but not limited to, graphic images and text, that is interpretable by an individual viewing the projected image in a meaningful manner. A display device refers to an electrical device used to present these images.
Environment: As used in this disclosure, an environment refers to the physical conditions surrounding an object. The term environment is often limited to the physical conditions that the object interacts with.
Field, Records, and Tables: As used in this disclosure, the terms field, record, and table are associated with a database. A field is a single item of information that is maintained by the database. The record refers to a collection of fields that form a related entry within the database. A table refers to a collection of records that are formed with the same field structure. In a relational database, the records contained in a first table contain a first field that is identical to a second field contained in the records of a second table. The use of an identical field allows the user to build meaningful relationship between the first table and the second table.
Image: As used in this disclosure, an image is an optical representation or reproduction of an indicia or of the appearance of something or someone. See indicia sentiment optical character recognition.
Include, But Are Not Limited To: As used in this disclosure, the term “include, but are not limited to” is a phrase used to introduce representative examples of structures that meet the requirements of the first phrase. As a first example of the use of the term “include, but are not limited to,” the phrase: “the first textile attaches to the second textile using a fastener such as a hook and loop fastener” is taken to mean that a hook and loop fastener is suitable to use as the fastener but is not meant to exclude the use of a zipper or a sewn seam. As a second example of the use of the term “include, but are not limited to,” the phrase: “the chemical substance is a halogen such as chlorine or bromine” is taken to mean that either chlorine or bromine are suitable for use as the halogen but is not meant to exclude the use of fluorine or iodine.
Indicia: As used in this disclosure, the term indicia refers to a set of markings that identify a sentiment.
Information, Data, and Knowledge: As used in this disclosure, the term information refers to a collection of objects that can be reduced to one or more declarative statements. By a declarative statement is meant a statement that is either true or false. The truth value of the statement need not be determined for the declarative statement to be considered information. The term data refers to the collection and organization of information for use as a reference and for subsequent analysis. The term knowledge refers to the context within which information and data are understood. Knowledge can be derived from multiple sources such as a study of the subject and related subject, theoretical analyses of the subject, practical experience, and personal experience with the subject.
Logical Device: As used in this disclosure, a logical device is a programmable electrical device that processes externally provided inputs to generate outputs that are determined from a previously programmed set of instructions.
Logic Module: As used in this disclosure, a logic module is an electrical device that accepts digital and analog inputs, processes the digital and analog inputs according to previously specified logical processes and provides the results of these previously specified logical processes as digital or analog outputs. The disclosure allows, but does not assume, that the logic module is programmable.
Sensor: As used in this disclosure, a sensor is a device that receives and responds in a predetermined way to a signal or stimulus. As further used in this disclosure, a threshold sensor is a sensor that generates a signal that indicates whether the signal or stimulus is above or below a given threshold for the signal or stimulus.
Sentiment: As used in this disclosure, a sentiment refers to a symbolic meaning or message that is communicated through the use of an object or an image, potentially including a text based image. A sentiment also refers to a symbolic meaning or message that is communicated through the announcement of an audible sound.
Such As: As used in this disclosure, the term “such as” is a conjunction that relates a first phrase to a subsequent phrase. The term “such as” is used to introduce representative examples of structures that meet the requirements of the first phrase. As a first example of the use of the term “such as,” the phrase: “the first textile attaches to the second textile using a fastener such as a hook and loop fastener” is taken to mean that a hook and loop fastener is suitable to use as the fastener but is not meant to exclude the use of a zipper or a sewn seam. As a second example of the use of the term “such as,” the phrase: “the chemical substance is a halogen such as chlorine or bromine” is taken to mean that either chlorine or bromine are suitable for use as the halogen but is not meant to exclude the use of fluorine or iodine.
Such That: As used in this disclosure, the term “such that” is a conjunction that relates a first phrase to a subsequent phrase. The term “such that” is used to place a further limitation or requirement to the first phrase. As a first example of the use of the term “such that,” the phrase: “the door attaches to the wall such that the door rotates relative to the wall” requires that the attachment of the door allows for this rotation. As a second example of the use of the term “such that,” the phrase: “the chemical substance is selected such that the chemical substance is soluble in water” requires that the selected chemical substance is soluble in water. As a third example of the use of the term “such that,” the phrase: “the lamp circuit is constructed such that the lamp circuit illuminates when the lamp circuit detects darkness” requires that the lamp circuit: a) detect the darkness; and, b) generate the illumination when the darkness is detected.
Transaction: As used in this disclosure, a transaction refers to an exchange between two entities. The exchange refers to a transfer selected from the group consisting of physical objects, data, information, and knowledge. In a legal environment, at transaction refers to exchanges between legally recognized entities such as individuals and incorporated organizations of individuals.
Transducer: As used in this disclosure, a transducer is a device that converts a physical quantity, such as pressure or brightness into an electrical signal or a device that converts an electrical signal into a physical quantity.
Virtual: As used in this disclosure, as used in this disclosure, the term virtual refers to a second device or process that for all practical purposes can replace the benefits provided by a first device or process. By for all practical purposes is taken to mean that the benefits provided by the second device or process need not exactly match the benefits provided by the first device or process.
Virtual Environment: As used in this disclosure, a virtual environment refers to the machine generated environment created by a virtual reality system.
Virtual Reality System: As used in this disclosure, the term virtual reality refers to a machine generated environment that is designed to interface with the senses of one or more individuals. This disclosure assumes that the individuals are living biological entities. The virtual reality system comprises a collection of display devices, sensor, and transducers that simulate the physical interactions between the one or more individuals and the machine generated environment.
WiFi™: As used in this disclosure, WiFi™ refers to the physical implementation of a collection of wireless electronic communication standards commonly referred to as IEEE 802.11x.
Wireless: As used in this disclosure, wireless is an adjective that is used to describe a communication link between two devices that does not require the use of physical cabling.

With respect to the above description, it is to be realized that the optimum dimensional relationship for the various components of the invention described above and in FIGS. 1 through 6 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A virtual reality shopping system comprising
a directory structure, an environment generation structure, and a plurality of avatars;
wherein the virtual reality shopping system is a virtual reality system;
wherein the directory structure presents a virtual storefront;
wherein the environment generation structure transforms the virtual storefront into a virtual environment;
wherein the plurality of avatars are virtual representations for the participants who represents the virtual storefront within the generated virtual environment.

2. The virtual reality shopping system according to claim 1
wherein the virtual reality shopping system is adapted for use with a client;
wherein the virtual reality shopping system provides a virtual environment that emulates the physical process of procuring one or more services;
wherein the virtual reality shopping system is a virtual shopping center.

3. The virtual reality shopping system according to claim 2
wherein the directory structure is a collection of individual virtual storefronts;
wherein each individual virtual storefront selected from the directory structure is a vending organization willing to execute a transaction with the client;
wherein the selected individual virtual storefront maintains a virtual storefront that the client accesses through the environment generation structure.

4. The virtual reality shopping system according to claim 3
wherein the directory structure comprises transportation services, shelter services, retail services, and personal need services;
wherein the transportation services is a subset of individual virtual storefronts selected from the directory structure that are associated with the transportation services;
wherein the transportation services comprises a plurality of transportation storefronts;
wherein the individual transportation storefronts contained in the transportation services are focused on the services necessary to transport passengers and cargo;
wherein the shelter services is a subset of individual virtual storefronts selected from the directory structure that are associated with the shelter services;
wherein the shelter services comprises a plurality of shelter storefronts;
wherein the individual shelter storefronts contained in the shelter services are focused on the services necessary to provide and manage housing for individual clients;
wherein the retail services is a subset of individual virtual storefronts selected from the directory structure that are associated with the retail services;
wherein the retail services comprises a plurality of retail storefronts;
wherein the individual retail storefronts contained in the retail services are focused on the sale of domestic articles;
wherein the personal need services is a subset of individual virtual storefronts selected from the directory structure that are associated with the personal need services;
wherein the personal need services comprises a plurality of personal need storefronts;
wherein the individual personal need storefronts contained in the personal need services are focused on the sale of services.

5. The virtual reality shopping system according to claim 4
wherein the environment generation structure is the structure of the virtual reality shopping system that generates the virtual environment the client experiences during the use of the virtual reality shopping system;
wherein the environment generation structure creates a virtual reality structure that interacts with the senses of the client.

6. The virtual reality shopping system according to claim 5
wherein the environment generation structure presents a first virtual environment that represents a shopping center;
wherein the first virtual environment presented by the environment generation structure offers the client access to the individual virtual storefronts that are accessible through the directory structure.

7. The virtual reality shopping system according to claim 6
wherein the environment generation structure generates a second virtual environment to the client that emulates a shopping experience within a selected individual virtual storefront;
wherein the client interacts with the selected individual virtual storefront through the first virtual environment and the second virtual environment to complete a transaction.

8. The virtual reality shopping system according to claim 7
wherein the environment generation structure directly controls the first virtual environment;
wherein the selected individual virtual storefront controls the second virtual environment through the facilities provided by the environment generation structure.

9. The virtual reality shopping system according to claim 8
wherein the environment generation structure comprises a logic module, a virtual reality display device, a plurality of joint motion devices, and a hand controller;
wherein the virtual reality display device electrically connects to the logic module;
wherein the logic module controls the operation of the virtual reality display device;
wherein each joint motion device selected from the plurality of joint motion devices forms an electric connection with the logic module;
wherein the logic module monitors the operation of each joint motion device;
wherein the hand controller is an interface structure;
wherein the hand controller is operated by the client;
wherein the hand controller allows the client to directly input operating instructions to the logic module.

10. The virtual reality shopping system according to claim 9
wherein the logic module is a logical device;
wherein the logic module forms a communication link with each individual virtual storefront selected from the directory structure;
wherein the logic module transmits input received from the client to the individual virtual storefront selected from the directory structure by the client;
wherein the logic module generates the second virtual environment received from the individual virtual storefront for the benefit of the client;
wherein the logic module forms a communication link with the client;
wherein the logic module presents the first virtual environment and the second virtual environment to the client;
wherein the logic module receives input from the client;
wherein the logic module uses the input received from the client to adjust the presentation of the first virtual environment to the client;
wherein the logic module further uses the input received from the client to adjust the presentation of the second virtual environment to the client;
wherein the logic module further uses the input received from the client to facilitate a transaction between the client and the selected individual virtual storefront presenting the second virtual environment.

11. The virtual reality shopping system according to claim 10
wherein the virtual reality display device is an interface structure;
wherein the virtual reality display device presents to the client the visual stimulation component of the virtual environment being presented to the client;
wherein the virtual reality display device presents to the client the audible stimulation component of the virtual environment being presented to the client;
wherein the virtual reality display device tracks the movement of the eyes of the client and uses the tracked movement to: a) adjust the virtual environment presented to the client; and, b) facilitate a transaction between the client and the selected individual virtual storefront;
wherein the virtual reality display device tracks the audible sounds made by the client and uses the captured sound to: a) adjust the virtual environment presented to the client; and, b) facilitate a transaction between the client and the selected individual virtual storefront;
wherein the virtual reality display device further measures the pulse rate, respiration rate, the blood pressure, and the temperature of the client;
wherein the virtual reality display device provides the pulse rate, respiration rate, the blood pressure, and the temperature of the client to the selected individual virtual storefront interacting with the client.

12. The virtual reality shopping system according to claim 11
wherein each joint motion device selected from the plurality of joint motion devices is a sensor;
wherein each joint motion device selected from the plurality of joint motion devices attaches to a joint of the client selected from the group consisting of: a) an elbow of the client; b) a wrist of the client; c) the knee of the client; and d) an ankle of the client;
wherein the plurality of joint motion devices are used to capture directional and pointing cues that are generated by the client;
wherein each joint motion device selected from the plurality of joint motion devices tracks the motion of its associated joint such that the logic module can use the detected motion to: a) adjust the virtual environment presented to the client; and, b) facilitate a transaction between the client and the selected individual virtual storefront.

13. The virtual reality shopping system according to claim 12
wherein each avatar selected from the plurality of avatars is an image;
wherein the image of each selected avatar presents indicia to the client that stimulates a sentiment that represents the participants of a potential transaction between the client and the selected individual virtual storefront;
wherein each avatar selected from the plurality of avatars is presented in a virtual environment selected from the group consisting of: a) the first virtual environment; b) the second virtual environment; and, c) both the first virtual environment and the second virtual environment.

14. The virtual reality shopping system according to claim 13
wherein the plurality of avatars comprises a client avatar and a virtual assistant avatar;
wherein the client avatar is an avatar selected from the plurality of avatars;
wherein the client avatar is an image;
wherein the client avatar presents indicia that stimulates a sentiment that the client avatar represents the image of the client;
wherein the virtual assistant avatar is an avatar selected from the plurality of avatars;
wherein the virtual assistant avatar is an image;
wherein the virtual assistant avatar presents indicia that stimulates a sentiment that the virtual assistant avatar represents the image of the selected individual virtual storefront interacting with the plurality of avatars.
